(19) United States
(12) Patent Application Publication
(10) Pub. No.: US 2026/0150071 A1
(43) Pub. Date: May 28, 2026

(54) DEREGISTRATION PROCEDURE OF PROTOCOL DATA UNIT SESSION

(71) Applicant: Telefonaktiebolaget LM Ericsson (publ), Stockholm (SE)

(72) Inventors: Yingjiao HE, Shanghai (CN); Jesús Ángel DE GREGORIO RODRIGUEZ, Madrid (ES); Emiliano MERINO VAZQUEZ, Madrid (ES); David CASTELLANOS ZAMORA, Madrid (ES); Qian CHEN, Mölndal (SE); Jongkyu WON, Seoul (KR); Wen ZHANG, Shanghai (CN)

(73) Assignee: Telefonaktiebolaget LM Ericsson (publ), Stockholm (SE)

(21) Appl. No.: 19/105,946

(22) PCT Filed: Aug. 25, 2023
(86) PCT No.: PCT/EP2023/073396

§ 371 Date: Feb. 24, 2025

Related U.S. Application Data
(60) Provisional application No. 63/373,511, filed on Aug. 25, 2022.

(51) Int. Cl. H04W 60/06; H04W 48/18; H04W 76/34

(52) U.S. Cl. CPC H04W 60/06; H04W 48/18; H04W 76/34

(57) ABSTRACT

Disclosed herein is a method 300 performed by an UDM 104. The method comprises: obtaining s302 a command for triggering deregistration of a network session associated with a SMF, and a UE, wherein the command indicates that reactivation of the network session is required; and after obtaining the command, transmitting s304 towards the SMF a deregistration notification request for triggering the SMF to perform the deregistration of the network session, wherein the deregistration notification request indicates that the network session being deregistered is requested to be reactivated.

### CROSS-REFERENCE TO RELATED APPLICATIONS

This application is a 35 U.S.C. § 371 National Stage of International Patent Application No. PCT/EP2023/073396, filed 2023 Aug. 25, which claims priority to U.S. provisional application No. 63/373,511, filed on 2022 Aug. 25. The above identified applications are incorporated by reference.

### TECHNICAL FIELD

Disclosed are embodiments related to methods and apparatus for performing deregistration procedure of Protocol Data Unit (PDU) session.

### BACKGROUND

3GPP Technical Specification (TS) 29.503 describes Unified Data Management (UDM) initiated Network Function (NF) deregistration. The relevant portion of the TS is reproduced below.

TS 29.503: 5.3.2.3.2 UDM initiated NF Deregistration

Figure 5.3.2.3.2-1 shows a scenario where the UDM notifies the registered NF about its deregistration (see also
3GPP TS 23.502 [3] figure 4.2.2.2.2-1 step 14 and 3GPP TS 23.502 [3] figure 4.26.4.1.1-1 step 14). The request
contains the deregCallbackUri URI for deregistration notification as received by the UDM during registration, and
Deregistration Data.
The UDM initiates the deregistration procedure when the UE is registered to the AMF which does not support CAG
feature and the CAG subscription of the UE changes and it is allowed to access the 5GS via CAG cell(s) only.
The UDM also initiates deregistration notification when UE moves to different AMF within same AMF-Set.
Deregistration notification shall not be sent if the nfInstanceId of the AMF initiating registration is same as the old
AMF already registered in UDM (e.g. when multiple PLMNs are hosted on same AMF and UE moves across
PLMNs).
The UDM also initiates the deregistration procedures towards the SMF of the old PDU session when a new PDU
session has been established with the same PDU session ID from a different SMF, during SM Context Transfer
procedure (see clause 4.26.5.3 of 3GPP TS 23.502 [3]) or when duplicated PDU sessions existing in the network
(e.g. the AMF failed to release the old PDU session before creation of the new PDU session with the same PDU
session ID).

FIG. 7 corresponds to FIG. 5.3.2.3.2-1 mentioned in the above cited section of TS. As shown in FIG. 7, during UDM initiated NF deregistration process, UDM transmits towards NF service consumer Deregistration Data. Information relative to the Deregistration Data provided in 3GPP TS 29.503 is reproduced below.

6.2.6.2.5 Type: DeregistrationData
Table 6.2.6.2.5-1: Definition of type DeregistrationData

| Attribute name | Data type | P | Cardinality | Description |
|---|---|---|---|---|
| deregReason | DeregistrationReason | M | 1 | String; see clause 6.2.6.3.3 |
| accessType | AccessType | C | 0 . . . 1 | Access type where the UE is deregistered. |
| | | | | Shall be present in Deregistration |
| | | | | Notifications sent to the AMF. |
| pduSessionId | PduSessionId | C | 0 . . . 1 | It shall be present if the deregistration of |
| | | | | SMF happens. |
| | | | | If present, indicates PDU Session ID for |
| | | | | which old SMF is deregistered. |
| newSmfInstanceId | NfInstanceId | O | 0 . . . 1 | NF Instance Id of the new SMF to which |
| | | | | the SMF context is transferred. |

6.2.6.3.3Enumeration: DeregistrationReason
The enumeration DeregistrationReason represents the reason for the Deregistration
Notification. It shall comply with the provisions defined in table 6.2.6.3.3-1.
Table 6.2.6.3.3-1: Enumeration DeregistrationReason

| Enumeration value | Description |
|---|---|
| “UE_INITIAL_REGISTRATION” | When sent by the HSS; indicates |
| | that the deregistration towards the |
| | UDM is due to an initial attach in |
| | EPS. |
| | When sent by the UDM; indicates |
| | that the deregistration in the old |
| | AMF is due to a new AMF serving |
| | the UE during an initial |
| | registration |
| | See 3GPP TS 23.502 [3] and |
| | 3GPP TS 23.632 [32]. |
| “UE_REGISTRATION_AREA_CHANGE” | see 3GPP TS 23.502 [3] |
| “SUBSCRIPTION_WITHDRAWN” | see 3GPP TS 23.502 [3] |
| “5GS_TO_EPS_MOBILITY” | see 3GPP TS 23.502 [3] and |
| | 3GPP TS 23.632 [32]. |
| “5GS_TO_EPS_MOBILITY_UE_INITIAL_REGISTRATION” | This value shall only be sent by |
| | the UDM. It indicates that the |
| | deregistration in AMF is due to an |
| | initial attach in EPS, See |
| | 3GPP TS 23.502 [3] and |
| | 3GPP TS 23.632 [32]. |
| “REREGISTRATION_REQUIRED” | see 3GPP TS 23.502 [3] |
| “SMF_CONTEXT_TRANSFERRED” | see 3GPP TS 23.502 [3] |
| reRegistrationRequired | This IE is only applicable to Nudr interface and shall not be included |
| | over the Nudm interface. |
| | This attribute may be included in notifications sent by the UDR to |
| | the UDM if the purgeFlag is also set to true in the same notification. |
| | When Nudr Data Change Notification is received including this |
| | attribute and the purgeFlag, both set to true, the UDM uses |
| | “REREGISTRATION_REQUIRED” as DeregistrationReason |
| | towards AMF. |
| | This attribute shall not be included and set to true if the |
| | adminDeregSubWithdrawn attribute is present and set to true. |
| | Absence of this IE shall be interpreted as false. |

3GPP TS 29.503 also describes resource (e) used to represent individual PDU session SMF registrations. The relevant portion of the cited section of the 3GPP is reproduced below.

TS29.505 5.2.9 Resource: IndividualSmfRegistration
5.2.9.1 Description
This resource is used to represent individual PDU session SMF registrations to be stored in the UDR.
This resource is modelled with the Document resource archetype (see clause C.1 of 3GPP TS 29.501 [7]).
5.2.9.2 Resource Definition
Resource URI: {apiRoot}/nudr-dr/<apiVersion>/{ueId}/context-data/smf-registrations/{pduSessionId}
This resource shall support the resource URI variables defined in table 5.2.9.2-1.
Table 5.2.9.2-1: Resource URI variables for this resource

| Name | Definition |
|---|---|
| apiRoot | See clause 6.4.1 |
| ueId | Represents the Subscription Identifier SUPI or GPSI (see 3GPP TS 23.501 [4] clause |
| | 5.9.2) |
| | pattern: See pattern of type VarUeId 3GPP TS 29.571 [3] |
| pduSessionId | The pduSessionId identifies an individual SMF registration. |

Additionally, 3GPP TS 29.503 describes resource standard methods. The relevant portion of the cited section of the 3GPP is reproduced below.

5.2.9.3 Resource Standard Methods
5.2.9.3.1 PUT
This method shall support the URI query parameters specified in table 5.2.9.3.1-1.
Table 5.2.9.3.1-1: URI query parameters supported by the PUT method on this resource

| Name | Data type | P | Cardinality | Description |
|---|---|---|---|---|
| n/a | | | | |

This method shall support the request data structures specified in table 5.2.9.3.1-2 and
the response data structures and response codes specified in table 5.2.9.3.1-3.
Table 5.2.9.3.1-2: Data structures supported by the PUT Request Body on this resource

| Data type | P | Cardinality | Description |
|---|---|---|---|
| SmfRegistration | M | 1 | The registration that is to be created |

Table 5.2.9.3.1-3: Data structures supported by the PUT Response Body on this resource

| | | | Response | |
|---|---|---|---|---|
| Data type | P | Cardinality | codes | Description |
| SmfRegistration | M | 1 | 201 | Upon success, a response body containing a representation |
| | | | Created | of the created Individual SmfRegistration resource shall be |
| | | | | returned. |
| n/a | | | 204 No | Upon success, an empty response body shall be returned. |
| | | | Content | |

NOTE:
In addition common data structures as listed in table 5.5-1 are supported.

5.2.9.3.2 DELETE
This method shall support the URI query parameters specified in table 5.2.9.3.2-1.
Table 5.2.9.3.2-1: URI query parameters supported by the DELETE method on this resource

| Name | Data type | P | Cardinality | Description |
|---|---|---|---|---|
| n/a | | | | |

This method shall support the request data structures specified in table 5.2.9.3.2-2
and the response data structures and response codes specified in table 5.2.9.3.2-3.
Table 5.2.9.3.2-2: Data structures supported by the DELETE Request Body on this resource

| Data type | P | Cardinality | Description |
|---|---|---|---|
| n/a | | | |

Table 5.2.9.3.2-3: Data structures supported by the DELETE Response Body on this resource

| | | | Response | |
|---|---|---|---|---|
| Data type | P | Cardinality | codes | Description |
| n/a | | | 204 No | Upon success, an empty response body shall be returned. |
| | | | Content | |

NOTE:
In addition common data structures as listed in table 5.5-1 are supported.

### SUMMARY

Certain challenges presently exist. For example, with wide deployment of 5G commercial network, deregistration of a PDU session for a wireless device due to administrative reasons (e.g., due to that the subscription of the wireless device has changed) and reactivation of the deregistered PDU session cannot be initiated by a Unified Data Management (UDM) or a Unified Data Repository (UDR). More specifically, in the existing art, UDR or UDM is not configured to indicate to a Session Management Function (SMF) that reactivation of a PDU session is needed when the UDR or the UDM instructs the SMF to perform deregistration of a PDU session. There is no procedure for readily reactivating the PDU session once the administrative reasons (e.g. a subscription change) causing the deregistration of the PDU session has been handled with respect to the wireless device, e.g. notified or indicated to the wireless device and/or other functions or nodes in the network.

For example, there may be a scenario where an end user of a wireless device (e.g., a user equipment (UE)) contacts a wireless network operator providing a subscription for one or more services with respect to the wireless device and requests to change the subscription for the wireless device (e.g., change the payment plan) for the one or more services. In such scenario, the wireless network operator may have their own UDM/UDR interworking application for handling the request for changing the payment plan and may use UDM/UDR solution to register a PDU session. But there is no existing method to request the wireless device to immediately apply for a new payment plan (such that the deregistered PDU session is reactivated).

Accordingly, in one aspect of the embodiments of this disclosure, there is provided a method performed by a unified data management, UDM. The method comprises obtaining a command for triggering deregistration of a network session associated with a session management function, SMF, and a user equipment, UE, wherein the command indicates that reactivation of the network session is required. The method further comprises, after obtaining the command, transmitting towards the SMF a deregistration notification request for triggering the SMF to perform the deregistration of the network session. The deregistration notification request indicates that the network session being deregistered is requested to be reactivated.

In another aspect, there is provided a method performed by a unified data repository, UDR. The method comprises obtaining a first command for changing a value of a flag included in a resource, wherein the resource is related to registration of a session management function, SMF, for a network session. The method further comprises, based on the first command, changing the value of the flag. The method further comprises, as a result of changing the value of the flag, transmitting towards a unified data management, UDM, a message including a second command for triggering deregistration of the network session, wherein each of the first and second commands indicates whether reactivation of the network session is required.

In another aspect, there is provided a method performed by a session management function, SMF. The method comprises receiving a deregistration notification request for requesting deregistration of a network session, wherein the deregistration notification request was transmitted by a unified data management, UDM. The method further comprises after receiving the deregistration notification request, performing deregistration of the network session, wherein the deregistration notification request indicates that the network session being deregistered is requested to be reactivated.

In another aspect, there is provided a computer program comprising instructions which when executed by processing circuitry cause the processing circuitry to perform the method of any one of the above embodiments.

In another aspect, there is provided a carrier containing the computer program of the above embodiment, wherein the carrier is one of an electronic signal, an optical signal, a radio signal, and a computer readable storage medium.

In another aspect, there is provided a unified data management, UDM. The UDM is configured to obtain a command for triggering deregistration of a network session associated with a session management function, SMF, and a user equipment, UE, wherein the command indicates that reactivation of the network session is required. The UDM is further configured to, after obtaining the command, transmit towards the SMF a deregistration notification request for triggering the SMF to perform the deregistration of the network session, wherein the deregistration notification request indicates that the network session being deregistered is requested to be reactivated.

In another aspect, there is provided a unified data repository, UDR. The UDR is configured to obtain a first command for changing a value of a flag included in a resource, wherein the resource is related to registration of a session management function, SMF, for a network session. The UDR is further configured to, based on the first command, change the value of the flag; and as a result of changing the value of the flag, transmit towards a unified data management, UDM, a message including a second command for triggering deregistration of the network session, wherein each of the first and second commands indicates whether reactivation of the network session is required.

In another aspect, there is provided a session management function, SMF. The SMF is configured to receive a deregistration notification request for requesting deregistration of a network session, wherein the deregistration notification request was transmitted by a unified data management, UDM. The SMF is further configured to, after receiving the deregistration notification request, perform deregistration of the network session, wherein the deregistration notification request indicates that the network session being deregistered is requested to be reactivated.

In another aspect, there is provided an apparatus. The apparatus comprises a processing circuitry and a memory, said memory containing instructions executable by said processing circuitry, whereby the apparatus is operative to perform the method of any one of embodiments described above.

The embodiments of this disclosure allow UDM and/or UDR to trigger deregistration of a PDU session from the UDM and the UDR with reactivation of the PDU session required.

The accompanying drawings, which are incorporated herein and form part of the specification, illustrate various embodiments.

### BRIEF DESCRIPTION OF THE DRAWINGS

The accompanying drawings, which are incorporated herein and form part of the specification, illustrate various embodiments.

FIG. 1 shows a system according to some embodiments.

FIG. 2 shows a process according to some embodiments.

FIG. 3 shows a process according to some embodiments.

FIG. 4 shows a process according to some embodiments.

FIG. 5 shows a process according to some embodiments.

FIG. 6 shows an apparatus according to some embodiments.

FIG. 7 shows a UDM initiated NF deregistration process.

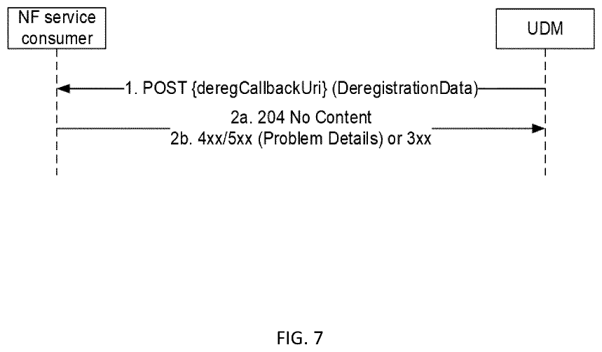

### DETAILED DESCRIPTION

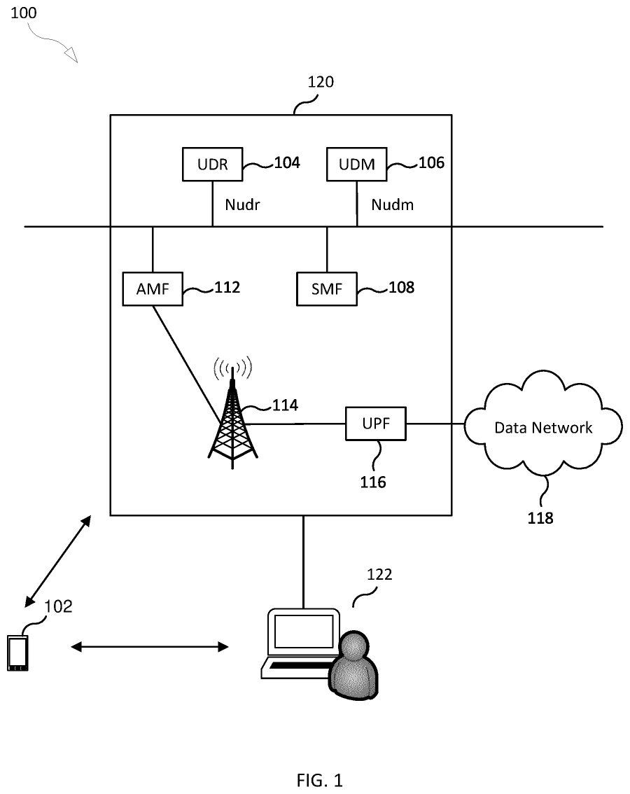

FIG. 1 shows an example system 100 according to some embodiments. System 100 comprises a user equipment (UE) 102 (e.g., a mobile phone, a tablet, a laptop, a drone, a vehicle, etc.), a data network 118, a wireless network system 120, and a customer center 122. Customer center 122 may be a customer center of a wireless network operator operating wireless network system 120.

Wireless network system 120 may comprise an UDR 104, an UDM 106, a Session Management Function (SMF) 108, an Access and Management Function (AMF) 112, a base station (e.g., gNB) 114, and a User Plane Function (UPF) 116. Note that FIG. 1 does not show all entities included in wireless network system 120 but only shows a portion of the system for simple explanation. Also even though FIG. 1 shows that customer center 122 is separate from wireless network system 120, in some embodiments, customer center 122 is included in wireless network system 120. UE 102 is connected to data network 118 (e.g., internet) via a wireless network provided by base station 114, and base station 114 is connected to data network 118 via UPF 116.

As discussed above, in some scenarios, an established PDU session needs to be released/deregistered but also needs to be reactivated (e.g., right away) after the release/deregistration.

Before further discussing the release/deregistration process, it is noted that, in this disclosure, the expression—releasing a PDU session—and the expression—deregistering a PDU session—are used interchangeably. Thus, in this disclosure, releasing a PDU session and deregistering a PDU session mean the same thing. Releasing/deregistering a PDU session may comprise deregistering one or more entities (e.g., SMF 108).

Referring back to the aforementioned scenarios, in one example, a user of UE 102 (herein after, just “UE 102”) may contact customer center 122 and request for changing its network plan (a.k.a., “payment plan”). More specifically, in case UE 102's current payment plan allows UE 102 to stream up to 5 GB of video per month, UE 102 may want to change its payment plan such that UE 102 can stream up to 10 GB of video per month. In such case, wireless network system 120 needs to deregister an established PDU session for UE 102 (e.g., to stop its current payment plan) but also needs to reactivate the PDU session after the deregistration (e.g., to start the new payment plan).

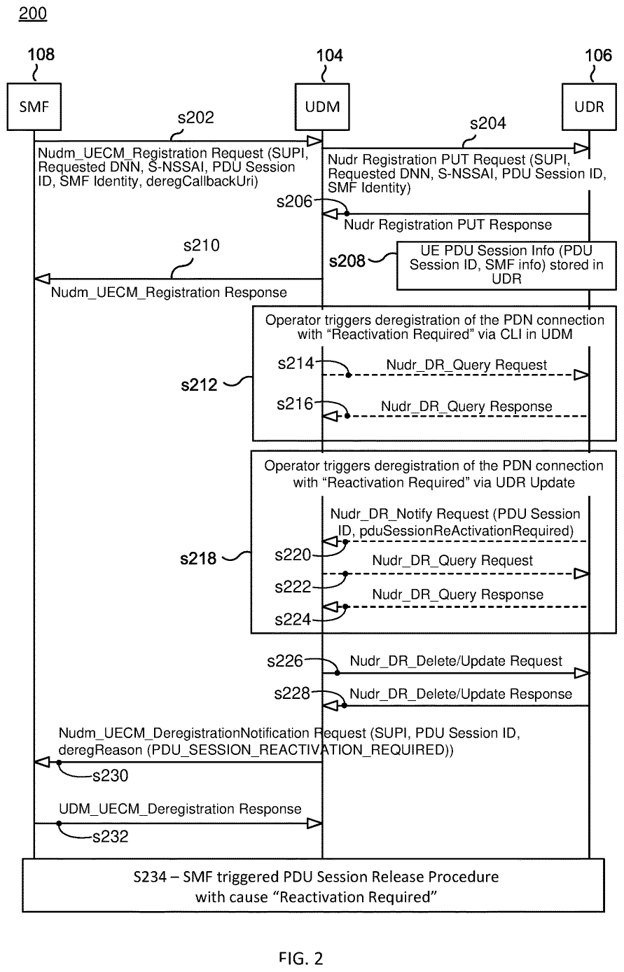

In order to satisfy the above needs, in some embodiments, wireless network system 120 is configured to perform a process 200 shown in FIG. 2. As shown in FIG. 2, process 200 includes steps for deregistering an established PDU session and for reactivating the deregistered PDU session. Detailed information about such steps is provided below.

Process 200 may begin with step s202. Step s202 comprises, during a PDU session establishment process, SMF 108 transmitting to UDM 104 a registration request for registering SMF 108 in UDM 104 for UE 102 and/or a PDU session associated with UE 102. In some embodiments, the registration request is the Nudm_UECM_Registration Request defined in 3GPP Technical Specification (TS) 23.502.

The registration request may comprise one or more of: a 5G globally unique subscription permanent identifier (SUPI) allocated to UE 102, a requested data network name (DNN), a single network slice selection assistance information (S-NSSAI) identifying a network slice, a PDU session ID identifying a PDU session, an SMF ID identifying SMF 108. Note that, in the embodiments of this disclosure, a generic public subscription identifier (GPSI) may be used instead of the SUPI.

Additionally, the registration request may comprise a resource identifier for receiving one or more notifications on deregistration of a network function. The resource identifier may be an Uniform Resource Identifier (URI) provided by AMF 112, and may be used for receiving (implicitly subscribed) notifications on deregistration of a network session. In one example, the resource identifier may be a deregCallbackUri defined in 3GPP TS 29.503.

After receiving the registration request, in step s204, UDM 104 may transmit to UDR 106 a registration PUT request. In some embodiments, the registration PUT request is Nudr_Registration PUT Request defined in 3GPP TS 29.505.

Like the registration request SMF 108 transmitted to UDM 104 in step s202, the registration PUT request may comprise one or more of: the SUPI, the DNN, the S-NSSAI, the PDU session ID, and the SMF ID. However, unlike the registration request transmitted in step s202, the registration PUT request does not include the resource identifier.

After receiving the registration PUT request, in step s206, UDR 106 may transmit to UDM 104 a registration PUT response responding to the registration PUT request. In some embodiments, the registration PUT response is Nudr_Registration PUT Response defined in 3GPP TS29.505.

In case the registration of SMF 108 is successful, in step s208, PDU session information may be stored in UDR 106. More specifically, an SMF ID identifying SMF 108 (same as the SMF ID included in the registration request and the registration PUT request) and a PDU session ID identifying a PDU session associated with SMF 108 (same as the PDU session ID included in the registration request and the registration PUT request) may be stored in UDR 106.

Upon receiving the registration PUT response, in step s210, UDM 104 may transmit to SMF 108 a registration response. In some embodiments, the registration response is the Nudm_UECM_Registration Response defined in 3GPP Technical Specification (TS) 23.502.

After establishing a PDU session (associated with SMF 108 and UE 102), as discussed above, there may be a scenario where the PDU session needs to be deregistered but needs to be reactivated after the deregistration. For example, UE 102 may contact customer center 122 and request for changing its payment plan. In such scenario, the PDU session needs to be deregistered temporarily and then to be reactivated such that UE 102's payment plan can be updated. Thus, the network operator of wireless network system 120 may need to trigger deregistration of the PDU session and reactivation of the deregistered PDU session.

Accordingly, process 200 may proceed to either step s212 or step s218. In both steps s212 and s218, the network operator triggers deregistration of the PDU session with an indication that once the PDU session is deregistered, the deregistered PDU session needs to be reactivated (herein after, “reactivation indication”).

One way of the network operator triggering the deregistration of the PDU session is performing step s212. In step s212, the network operator may provide Operation and Management (O&N) Command Line Interface (CLI) command(s) (herein after, “CLI command”) to UDM 104. For example, UDM 104 may be provided with a computer terminal capable of receiving CLI command, and the network operator may enter into the computer terminal the CLI command for triggering deregistration of the PDU session with the reactivation indication.

The CLI command may include information about a SUPI (e.g., identifying UE 102), a PDU session ID (e.g., identifying the PDU session that needs to be deregistered), and the reactivation indication (“pduSessionReActivationRequired” indication).

The CLI command may also include an SMF ID (e.g., identifying SMF 108) identifying an SMF that needs to be deregistered. In case, the CLI command does not include the SMF ID, in optional step s214, UDM 104 may transmit to UDR 106 a request (e.g., “Nudr_DR_Query Request”) for the SMF ID, and in optional step s216, UDR 106 may transmit to UDM 104 a response including the requested SMF ID. In some embodiments, the request in step s214 and/or the response in step s216 may include the PDU session ID and/or the SUPI (or GPSI).

Instead of performing step s212, step s218 may be performed to trigger the deregistration process.

In some embodiments, UDR 106 is configured to store PDU session information identifying the PDU session to be released by SMF 108. The PDU session information may also include a resource related to SMF registration (e.g., “smfRegistration resource”), and the SMF registration resource may include a flag (e.g., “pduSessionReActivationRequired” flag) associated with the PDU session to be released. The flag may indicate whether a session reactivation is required for the PDU session. Table below shows information that may be included in the smfRegistration resource.

TABLE
Definition of type SmfRegistration

| Attribute name | Data type | P | Cardinality | Description |
|---|---|---|---|---|
| smfInstanceId | NfInstanceId | M | 1 | NF Instance Id of the SMF |
| . . . | . . . | . . . | . . . | . . . |
| pduSessionId | PduSessionId | M | 1 | PDU Session ID |
| singleNssai | Snssai | M | 1 | A single Network Slice Selection Assistance |
| | | | | Information |
| . . . | . . . | . . . | . . . | . . . |
| pduSessionReActivationRequired | boolean | C | 0 . . . 1 | This IE is only applicable to Nudr interface and |
| | | | | shall not be included over the Nudm interface. |
| | | | | This attribute may be included in notifications |
| | | | | sent by the UDR to the UDM. |
| | | | | When Nudr Data Change Notification is |
| | | | | received including this attribute set to true, the |
| | | | | UDM uses |
| | | | | “PDU_SESSION_REACTIVATION_REQUESTED” |
| | | | | as DeregistrationReason towards SMF. |
| | | | | Absence of this IE shall be interpreted as false. |

In step s218, the deregistration process may be triggered by changing the value of this flag in the SMF registration resource.

More specifically, the network operator may change (or set) the value of the flag (i.e., a change in the “pduSessionReActivationRequired” flag) such that the flag value indicates that the session reactivation is required. Such change or the set of the flag value may trigger, in optional step s220, UDR 106 to transmit to UDM 104 a notification message (e.g., “Nudr_DR_Notify Request”) indicating the change of the value of the flag. The notification message may comprise a Uniform Resource Identifier (URI) pointing to the PDU session to be released and may indicate that reactivation of the network session is required and/or requested. More specifically, the notification message may comprise a flag indicating the reason for transmitting the notification message, and the value of the flag may indicate that reactivation of the network session is required and/or requested. In response to receiving the notification, UDM 104 may transmit to UDR 106 an optional acknowledgement message acknowledging the receipt of the notification message.

Additionally, upon receiving the notification, in optional step s222, UDM 104 may use the received URI pointing to the PDU session to retrieve (e.g., from UDR 106) all the information related to the PDU session as registered by SMF 108 initially. The information related to the PDU session may include the SMF ID identifying SMF 108. More specifically, UDM 104 may transmit to UDR 106 a query request (e.g., “Nudr_DR_Query Request”) for fetching the PDU session ID identifying the PDU session to be released and the SMF ID identifying the SMF that needs to be deregistered. Upon receiving the query request, in optional step s224, UDR 106 may transmit to UDM 104 the requested information. In some embodiments, the request in step s222 and/or the response in step s224 may include the PDU session ID and/or the SUPI (or GPSI).

After step s212 or step s218 is performed, process 200 may proceed to steps s226 and s228. In s226, UDM 104 transmits to UDR 106 a request to delete/update the PDU session information (i.e., the information about the PDU session to be released, which includes the SMF registration resource). The request may include a PDU session ID identifying the PDU session to be released. In some embodiments, the request is the Nudr_DR_Delete Request or the Nudr_DR_Update Request defined in 3GPP Technical Specification (TS) 29.504. But UDM 104 may keep locally the information about the SUPI, the PDU session ID, and the SMF ID in order for UDM 104 to send to SMF 108. In some embodiments, the request in step s226 and/or the response in step s228 may include the PDU session ID and/or the SUPI (or GPSI).

Upon receiving the request, in step s228, UDR 106 may delete/update the PDU session information and transmit to UDM 104 a response indicating the completion of the deletion/update.

After step s228, process 200 may proceed to step s230. In step s230, UDM 104 may transmit to SMF 108 a deregistration message informing SMF 108 to perform the deregistration of the PDU session for UE 102. In one example, the deregistration message is the Nudm_UECM_DeregistrationNotification Request defined in 3GPP Technical Specification (TS) 23.502.

The deregistration message may include the SUPI identifying UE 102, the PDU session ID identifying the PDU session to be released/deregistered, and a deregistration reason field. The table provided below shows example information that may be included in the deregistration reason field.

TABLE
Enumeration DeregistrationReason

| Enumeration value | Description |
|---|---|
| “UE_INITIAL_REGISTRATION” | When sent by the HSS; indicates that the |
| | deregistration towards the UDM is due to an initial |
| | attach in EPS. |
| | When sent by the UDM; indicates that the |
| | deregistration in the old AMF is due to a new AMF |
| | serving the UE during an initial registration |
| | See 3GPP TS 23.502 [3] and 3GPP TS 23.632 [32]. |
| “UE_REGISTRATION_AREA_CHANGE” | see 3GPP TS 23.502 [3] |
| “SUBSCRIPTION_WITHDRAWN” | see 3GPP TS 23.502 [3] |
| “5GS_TO_EPS_MOBILITY” | see 3GPP TS 23.502 [3] and 3GPP TS 23.632 [32]. |
| “5GS_TO_EPS_MOBILITY_UE_INITIAL_REGISTRATION” | This value shall only be sent by the UDM. It |
| | indicates that the deregistration in AMF is due to an |
| | initial attach in EPS, See 3GPP TS 23.502 [3] and |
| | 3GPP TS 23.632 [32]. |
| “REREGISTRATION_REQUIRED” | see 3GPP TS 23.502 [3] |
| “SMF_CONTEXT_TRANSFERRED” | see 3GPP TS 23.502 [3] |
| “PDU_SESSION_REACTIVATION_REQUIRED” | Indicates that the PDU session being released is |
| | requested to be re-activated |

As shown above, the deregistration reason field is capable of indicating whether the PDU session being released is requested to be reactivated. More specifically, the deregistration reason field can be set to have a value corresponding to “PDU_Session_Reactivation_Required.”

Upon receiving the deregistration message, in step s232, SMF 108 may transmit to UDM 104 a deregistration response. The deregistration response may indicate the receipt of the deregistration request. In some embodiments, the registration response is the Nudm_UECM_DeregistrationNotification Response defined in 3GPP Technical Specification (TS) 23.502.

Also, upon receiving the deregistration message, in step s232, SMF 108 may trigger a PDU session release procedure with the reactivation indication. In the PDU session release procedure with the reactivation indication, SMF 108 may indicate to UE 102 that the PDU session that is being released needs to be reactivated, and SMF 108's such indication may trigger UE 102 to send a re-attach message after the PDU session is released.

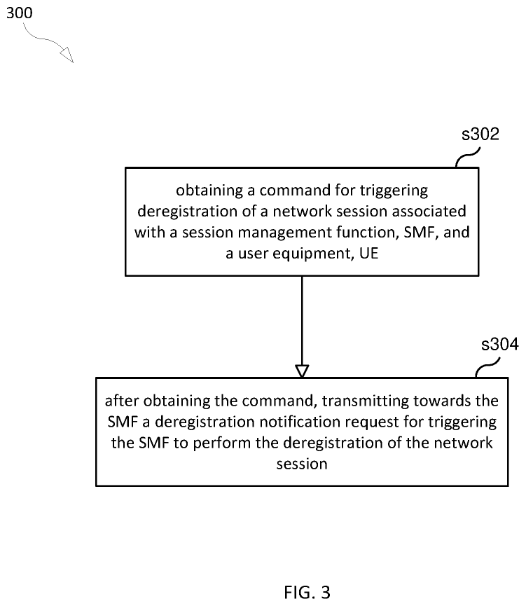

FIG. 3 shows a process 300 performed by a unified data management, UDM. Process 300 may begin with step s302. Step s302 comprises obtaining a command for triggering deregistration of a network session associated with a session management function, SMF, and a user equipment, UE, wherein the command indicates that reactivation of the network session is required. Step s304 comprises, after obtaining the command, transmitting towards the SMF a deregistration notification request for triggering the SMF to perform the deregistration of the network session. The deregistration notification request indicates that the network session being deregistered is requested to be reactivated.

In some embodiments, the command is generated at the UDM or at a unified data repository, UDR.

In some embodiments, the command is generated at the UDM, and the command comprises (i) a globally unique subscription permanent identifier, SUPI, allocated to the UE and/or a generic public subscription identifier (GPSI), and (ii) a network session identifier identifying the network session.

In some embodiments, the command also comprises a SMF identifier identifying the SMF or the method comprises retrieving the SMF identifier from the UDR.

In some embodiments, the process comprises receiving a message including the command transmitted by the UDR, and the command includes an uniform resource identifier, URI, pointing to the network session.

In some embodiments, the message is a Nudr_DR_Notify Request.

In some embodiments, the transmission of the message by the UDR was triggered by changing a value of a flag included in a resource related to registration of the SMF for the network session, and the value of the flag indicates whether reactivation of the network session is required.

In some embodiments, the process comprises as a result of receiving the message, transmitting towards the UDR a query request for requesting a network session ID identifying the network session and an SMF ID identifying the SMF; and receiving the network session ID and the SMF ID.

In some embodiments, the process comprises storing a SUPI allocated to the UE, a network session identifier identifying the network session, and a SMF identifier identifying the SMF; and triggering the UDM to release one or more resources related to the network session.

In some embodiments, the deregistration notification request indicates a reason for deregistering the network session.

In some embodiments, the deregistration notification request comprises a SUPI allocated to the UE, a network session identifier identifying the network session, and a SMF identifier identifying the SMF.

In some embodiments, the deregistration notification request is a Nudm_UECM_DeregistrationNotification Request.

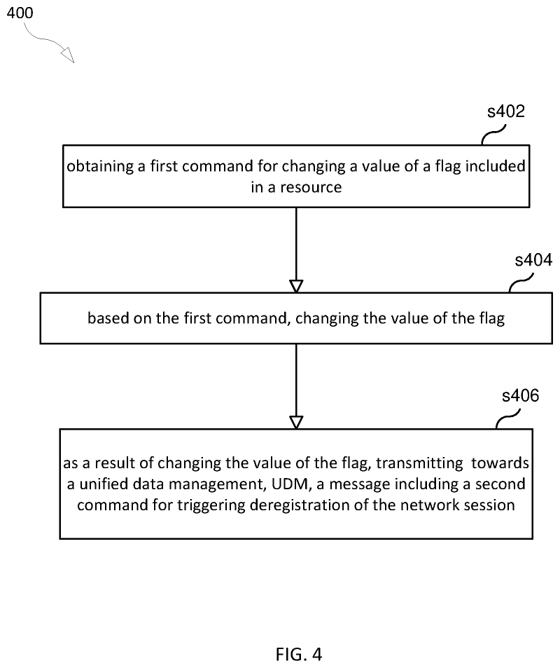

FIG. 4 shows a process 400 performed by a unified data repository, UDR. Process 400 may begin with step s402. Step s402 comprises obtaining a first command for changing a value of a flag included in a resource, wherein the resource is related to registration of a session management function, SMF, for a network session. Step s404 comprises based on the first command, changing the value of the flag. Step s406 comprises, as a result of changing the value of the flag, transmitting towards a unified data management, UDM, a message including a second command for triggering deregistration of the network session, wherein each of the first and second commands indicates whether reactivation of the network session is required.

In some embodiments, the resource comprises a SUPI, a SMF identifier, ID, identifying the SMF, a network session ID identifying the network session, a single network slice selection assistance information, SNSSAI, and a bit indicating whether reactivation of the network session is required.

In some embodiments, the second command comprises a resource ID pointing to the network session, and the process comprises: receiving a query request for requesting an SMF ID identifying the SMF and a network session ID identifying the network session and; and transmitting towards the UDM the SMF ID and the network session ID.

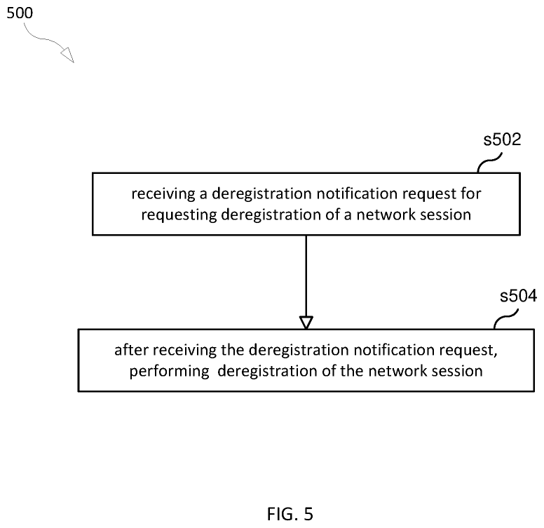

FIG. 5 shows a process 500 performed by a session management function, SMF. Process 500 may begin with step s502. Step s502 comprises receiving a deregistration notification request for requesting deregistration of a network session, wherein the deregistration notification request was transmitted by a unified data management, UDM. Step s504 comprises, after receiving the deregistration notification request, performing deregistration of the network session, wherein the deregistration notification request indicates that the network session being deregistered is requested to be reactivated.

In some embodiments, the deregistration notification request comprises a field for identifying a reason for deregistering the network session, and the indication that the network session being deregistered is requested to be reactivated is included in the field.

In some embodiments, the deregistration notification request comprises a SUPI allocated to the UE, a network session identifier identifying the network session, and a SMF identifier identifying the SMF.

In some embodiments, the deregistration notification request is a Nudm_UECM_Deregistration request.

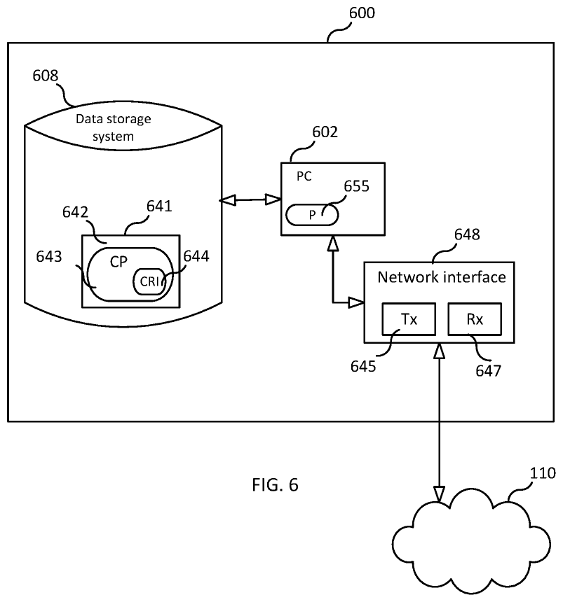

FIG. 6 is a block diagram of an apparatus 600, according to some embodiments, for implementing any one or more of SMF 108, UDM 104, or UDR 106. As shown in FIG. 6, apparatus 600 may comprise: processing circuitry (PC) 602, which may include one or more processors (P) 655 (e.g., a general purpose microprocessor and/or one or more other processors, such as an application specific integrated circuit (ASIC), field-programmable gate arrays (FPGAs), and the like), which processors may be co-located in a single housing or in a single data center or may be geographically distributed (i.e., apparatus 600 may be a distributed computing apparatus); a network interface 648 comprising a transmitter (Tx) 645 and a receiver (Rx) 647 for enabling apparatus 600 to transmit data to and receive data from other nodes connected to a network 110 (e.g., an Internet Protocol (IP) network) to which network interface 648 is connected (directly or indirectly) (e.g., network interface 648 may be wirelessly connected to the network 110, in which case network interface 648 is connected to an antenna arrangement); and a local storage unit (a.k.a., “data storage system”) 608, which may include one or more non-volatile storage devices and/or one or more volatile storage devices. In embodiments where PC 602 includes a programmable processor, a computer program product (CPP) 641 may be provided. CPP 641 includes a computer readable medium (CRM) 642 storing a computer program (CP) 643 comprising computer readable instructions (CRI) 644. CRM 642 may be a non-transitory computer readable medium, such as, magnetic media (e.g., a hard disk), optical media, memory devices (e.g., random access memory, flash memory), and the like. In some embodiments, the CRI 644 of computer program 643 is configured such that when executed by PC 602, the CRI causes apparatus 600 to perform steps described herein (e.g., steps described herein with reference to the flow charts). In other embodiments, apparatus 600 may be configured to perform steps described herein without the need for code. That is, for example, PC 602 may consist merely of one or more ASICs. Hence, the features of the embodiments described herein may be implemented in hardware and/or software.

### SUMMARY OF EMBODIMENTS

Some of the embodiments that have been described above may be summarized in the following manner:
A1. A method (300) performed by a unified data management, UDM (104), the method comprising:
obtaining (s302) a command for triggering deregistration of a network session associated with a session management function, SMF, and a user equipment, UE, wherein the command indicates that reactivation of the network session is required; and
after obtaining the command, transmitting (s304) towards the SMF a deregistration notification request for triggering the SMF to perform the deregistration of the network session, wherein
the deregistration notification request indicates that the network session being deregistered is requested to be reactivated.
A2. The method of embodiment A1, wherein the command is generated at the UDM or at a unified data repository, UDR.
A3. The method of embodiment A1 or A2, wherein
the command is generated at the UDM, and
the command comprises (i) a globally unique subscription permanent identifier, SUPI, allocated to the UE and/or a generic public subscription identifier (GPSI), and (ii) a network session identifier identifying the network session.
A4. The method of any one of embodiments A1-A3, wherein the command also comprises a SMF identifier identifying the SMF or the method comprises retrieving the SMF identifier from the UDR.
A5. The method of embodiment A1 or A2, wherein
the method comprises receiving a message including the command transmitted by the UDR, and
the command includes an uniform resource identifier, URI, pointing to the network session.
A6. The method of embodiment A5, wherein the message is a Nudr_DR_Notify Request.
A7. The method of embodiment A5 or A6, wherein
the transmission of the message by the UDR was triggered by changing a value of a flag included in a resource related to registration of the SMF for the network session, and
the value of the flag indicates whether reactivation of the network session is required.
A8. The method of any one of embodiments A5-A7, comprising:
as a result of receiving the message, transmitting towards the UDR a query request for requesting a network session ID identifying the network session and an SMF ID identifying the SMF; and
receiving the network session ID and the SMF ID.
A9. The method of any one of embodiments A5-A8, comprising:
storing a SUPI allocated to the UE, a network session identifier identifying the network session, and a SMF identifier identifying the SMF; and
triggering the UDM to release one or more resources related to the network session.
A10. The method of any one of embodiments A1-A9, wherein
the deregistration notification request indicates a reason for deregistering the network session.
A11. The method of any one of embodiments A1-A10, wherein the deregistration notification request comprises a SUPI allocated to the UE, a network session identifier identifying the network session, and a SMF identifier identifying the SMF.
A12. The method of embodiment any one of A1-A11, wherein the deregistration notification request is a Nudm_UECM_DeregistrationNotification Request.
B1. A method (400) performed by a unified data repository, UDR (106), the method comprising:
obtaining (s402) a first command for changing a value of a flag included in a resource, wherein the resource is related to registration of a session management function, SMF, for a network session;
based on the first command, changing (s404) the value of the flag; and
as a result of changing the value of the flag, transmitting (s406) towards a unified data management, UDM, a message including a second command for triggering deregistration of the network session, wherein each of the first and second commands indicates whether reactivation of the network session is required.
B2. The method of embodiment B1, wherein the resource comprises a SUPI, a SMF identifier, ID, identifying the SMF, a network session ID identifying the network session, a single network slice selection assistance information, SNSSAI, and a bit indicating whether reactivation of the network session is required.
B3. The method of embodiment B1 or B2, wherein
the second command comprises a resource ID pointing to the network session, and
the method comprises:
   receiving a query request for requesting an SMF ID identifying the SMF and a network session ID identifying the network session and; and
   transmitting towards the UDM the SMF ID and the network session ID.
C1. A method (500) performed by a session management function, SMF (108), the method comprising:
receiving (s502) a deregistration notification request for requesting deregistration of a network session, wherein the deregistration notification request was transmitted by a unified data management, UDM; and
after receiving the deregistration notification request, performing (s504) deregistration of the network session, wherein
the deregistration notification request indicates that the network session being deregistered is requested to be reactivated.
C2. The method of embodiment C1, wherein
the deregistration notification request comprises a field for identifying a reason for deregistering the network session, and
the indication that the network session being deregistered is requested to be reactivated is included in the field.
C3. The method of embodiment C1 or C2, wherein the deregistration notification request comprises a SUPI allocated to the UE, a network session identifier identifying the network session, and a SMF identifier identifying the SMF.
C4. The method of any one of embodiments C1-C3, wherein the deregistration notification request is a Nudm_UECM_Deregistration request.
D1. A computer program (600) comprising instructions (644) which when executed by processing circuitry (602) cause the processing circuitry to perform the method of any one of embodiments A1-C4.
D2. A carrier containing the computer program of embodiment D1, wherein the carrier is one of an electronic signal, an optical signal, a radio signal, and a computer readable storage medium.
E1. A unified data management, UDM (104), the UDM being configured to:
obtain (s302) a command for triggering deregistration of a network session associated with a session management function, SMF, and a user equipment, UE, wherein the command indicates that reactivation of the network session is required; and
after obtaining the command, transmit (s304) towards the SMF a deregistration notification request for triggering the SMF to perform the deregistration of the network session, wherein
the deregistration notification request indicates that the network session being deregistered is requested to be reactivated.
E2. The UDM of embodiment E1, wherein the UDM is configured to perform the method of any one of embodiments A2-A12.
F1. A unified data repository, UDR (106), the UDR being configured to:
obtain (s402) a first command for changing a value of a flag included in a resource, wherein the resource is related to registration of a session management function, SMF, for a network session;
based on the first command, change (s404) the value of the flag; and
as a result of changing the value of the flag, transmit (s406) towards a unified data management, UDM, a message including a second command for triggering deregistration of the network session, wherein each of the first and second commands indicates whether reactivation of the network session is required.
F2. The UDR of embodiment F1, wherein the UDR is configured to perform the method of any one of embodiments B2-B3.
G1. A session management function, SMF (108), the SMF being configured to:
receive (s502) a deregistration notification request for requesting deregistration of a network session, wherein the deregistration notification request was transmitted by a unified data management, UDM; and
after receiving the deregistration notification request, perform (s504) deregistration of the network session, wherein
the deregistration notification request indicates that the network session being deregistered is requested to be reactivated.
G2. The SMF of embodiment G1, wherein the SMF is configured to perform the method of any one of embodiments C2-C4.
H1. An apparatus (600) comprising:
a processing circuitry (602); and
a memory (641), said memory containing instructions executable by said processing circuitry, whereby the apparatus is operative to perform the method of any one of embodiments A1-C4.

### CONCLUSION

While various embodiments are described herein, it should be understood that they have been presented by way of example only, and not limitation. Thus, the breadth and scope of this disclosure should not be limited by any of the above described exemplary embodiments. Moreover, any combination of the above-described elements in all possible variations thereof is encompassed by the disclosure unless otherwise indicated herein or otherwise clearly contradicted by context.

Additionally, while the processes described above and illustrated in the drawings are shown as a sequence of steps, this was done solely for the sake of illustration. Accordingly, it is contemplated that some steps may be added, some steps may be omitted, the order of the steps may be re-arranged, and some steps may be performed in parallel.

### Additional Disclosure

Definition of type SmfRegistration

| Attribute name | Data type | P | Cardinality | Description |
|---|---|---|---|---|
| smfInstanceId | NfInstanceId | M | 1 | NF Instance Id of the SMF |
| . . . | . . . | . . . | . . . | . . . |
| pduSessionId | PduSessionId | M | 1 | PDU Session ID |
| singleNssai | Snssai | M | 1 | A single Network Slice Selection Assistance |
| | | | | Information |
| . . . | . . . | . . . | . . . | . . . |
| pduSessionReActivationRequired | boolean | C | 0 . . . 1 | This IE is only applicable to Nudr interface |
| | | | | and shall not be included over the Nudm |
| | | | | interface. |
| | | | | This attribute may be included in |
| | | | | notifications sent by the UDR to the UDM. |
| | | | | When Nudr Data Change Notification is |
| | | | | received including this attribute set to true, |
| | | | | the UDM uses |
| | | | | “PDU_SESSION_REACTIVATION_REQUESTED” |
| | | | | as DeregistrationReason towards SMF. |
| | | | | Absence of this IE shall be interpreted as |
| | | | | false. |

### Enumeration: DeregistrationReason

The enumeration DeregistrationReason represents the reason for the Deregistration Notification. It shall comply with the provisions defined in table 6.2.6.3.3-1.

TABLE 6.2.6.3.3-1
Enumeration DeregistrationReason

| Enumeration value | Description |
|---|---|
| “UE_INITIAL_REGISTRATION” | When sent by the HSS; indicates that |
| | the deregistration towards the UDM is |
| | due to an initial attach in EPS. |
| | When sent by the UDM; indicates that |
| | the deregistration in the old AMF is due |
| | to a new AMF serving the UE during an |
| | initial registration |
| | See 3GPP TS 23.502 [3] and |
| | 3GPP TS 23.632 [32]. |
| “UE_REGISTRATION_AREA_CHANGE” | see 3GPP TS 23.502 [3] |
| “SUBSCRIPTION_WITHDRAWN” | see 3GPP TS 23.502 [3] |
| “5GS_TO_EPS_MOBILITY” | see 3GPP TS 23.502 [3] and |
| | 3GPP TS 23.632 [32]. |
| “5GS_TO_EPS_MOBILITY_UE_INITIAL_REGISTRATION” | This value shall only be sent by the |
| | UDM. It indicates that the deregistration |
| | in AMF is due to an initial attach in EPS, |
| | See 3GPP TS 23.502 [3] and |
| | 3GPP TS 23.632 [32]. |
| “REREGISTRATION_REQUIRED” | see 3GPP TS 23.502 [3] |
| “SMF_CONTEXT_TRANSFERRED” | see 3GPP TS 23.502 [3] |
| “PDU_SESSION_REACTIVATION_REQUIRED” | Indicates that the PDU session being |
| | released is requested to be re- |
| | activated |

1-28. (canceled)

29. A method performed by a unified data management (UMN) the method comprising:
obtaining a command for triggering deregistration of a network session associated with a session management function (SMF) and a user equipment (UE) wherein the command is transmitted by a unified data repository (UDR) and the command includes a uniform resource identifier (URI) pointing to the network session and indicates that reactivation of the network session is required; and
after obtaining the command, transmitting towards the SMF a deregistration notification request for triggering the SMF to perform the deregistration of the network session, wherein
the deregistration notification request indicates that the network session being deregistered is requested to be reactivated.

30. The method of claim 29, wherein the command also comprises a SMF identifier identifying the SMF or the method comprises retrieving the SMF identifier from the UDR.

31. The method of claim 29, wherein the message is a Nudr_DR_Notify Request.

32. The method of claim 29, wherein
the transmission of the message by the UDR was triggered by changing a value of a flag included in a resource related to registration of the SMF for the network session, and
the value of the flag indicates whether reactivation of the network session is required.

33. The method of claim 29, comprising:
as a result of receiving the message, transmitting towards the UDR a query request for requesting a network session ID identifying the network session and an SMF ID identifying the SMF; and
receiving the network session ID and the SMF ID.

34. The method of claim 29, comprising:
storing a SUPI allocated to the UE, a network session identifier identifying the network session, and a SMF identifier identifying the SMF; and
triggering the UDM to release one or more resources related to the network session.

35. The method of claim 29, wherein
the deregistration notification request indicates a reason for deregistering the network session.

36. The method of claim 29, wherein the deregistration notification request comprises a SUPI allocated to the UE, a network session identifier identifying the network session, and a SMF identifier identifying the SMF.

37. The method of claim 29, wherein the deregistration notification request is a Nudm_UECM_DeregistrationNotification Request.

38. A method performed by a unified data repository (UDR) the method comprising:
obtaining a first command for changing a value of a flag included in a resource, wherein the resource is related to registration of a session management function (SMF) for a network session;
based on the first command, changing the value of the flag; and
as a result of changing the value of the flag, transmitting towards a unified data management UDM a message including a second command for triggering deregistration of the network session, wherein each of the first and second commands indicates whether reactivation of the network session is required.

39. The method of claim 38, wherein the resource comprises a SUPI, a SMF identifier (ID) identifying the SMF, a network session ID identifying the network session, a single network slice selection assistance information (SNSSAI) and a bit indicating whether reactivation of the network session is required.

40. The method of claim 38, wherein
the second command comprises a resource ID pointing to the network session, and
the method comprises:
receiving a query request for requesting an SMF ID identifying the SMF and a network session ID identifying the network session and; and
transmitting towards the UDM the SMF ID and the network session ID.

41. A non-transitory computer readable storage medium storing a computer program comprising instructions which when executed by processing circuitry of an apparatus causes the apparatus to perform the method of claim 29.

42. A unified data management (UDM) the UDM being configured to:
obtain a command for triggering deregistration of a network session associated with a session management function (SMF) and a user equipment (UE) wherein the command is transmitted by a unified data repository (UDR) and the command includes a uniform resource identifier (URI) pointing to the network session and indicates that reactivation of the network session is required; and
after obtaining the command, transmit towards the SMF a deregistration notification request for triggering the SMF to perform the deregistration of the network session, wherein
the deregistration notification request indicates that the network session being deregistered is requested to be reactivated.

43. The UDM of claim 42, wherein the UDM is configured to perform the method of claim 29.

44. A unified data repository (UDR) the UDR being configured to:
obtain a first command for changing a value of a flag included in a resource, wherein the resource is related to registration of a session management function (SMF) for a network session;
based on the first command, change the value of the flag; and
as a result of changing the value of the flag, transmit towards a unified data management (UDM) a message including a second command for triggering deregistration of the network session, wherein each of the first and second commands indicates whether reactivation of the network session is required.

45. The UDR of claim 44, wherein the UDR is configured to perform the method of claim 29.
